(19) United States
(12) Patent Application Publication
(10) Pub. No.: US 2003/0231925 A1
(43) Pub. Date: Dec. 18, 2003

(54) Visual inspection coupler

(76) Inventor: Ching-Cheng Chen, Hsintien City (TW)

Correspondence Address: BACON & THOMAS, PLLC, 625 SLATERS LANE, FOURTH FLOOR, ALEXANDRIA, VA, 22314

(21) Appl. No.: 10/167,596

(22) Filed: Jun. 13, 2002

(51) Int. Cl. F16B 12/36

(52) U.S. Cl. 403/294

(57) ABSTRACT

A visual inspection coupler adapted for connecting two members in longitudinal direction, includes a female connector fixedly fastened to a transverse side of one of the two members to be connected, the female connector having at least one transversely extended coupling groove, and a male connector fixedly fastened to a transverse side of the other of the two members to be connected, the male connector having at least one transversely extended coupling rib adapted for engaging into the at least one coupling groove of the female connector. The engagement between the at least one coupling groove and the at least one coupling rib enables the worker to inspect the connection of the two members visually.

### BACKGROUND OF THE INVENTION

1. Field of the Invention

The present invention relates to a coupler and, more particularly, to a visual inspection coupler, which enables the inspector to check the connection of the connected members visually.

2. Description of Related Art

It has been more than two decades since the use of coupler means to connect, for example, reinforcing bars in a line. Nowadays, various coupler means for connecting reinforcing bars, profiled irons, or other building construction materials are known. According to one conventional design, a tubular steel connecting member is used and sleeved onto one end of each of the two reinforcing bars to be connected, and then deformed by a hydraulic press. According to another conventional design, a screw joint is employed for enabling two members to be connected in a line. According to still another conventional design, a sleeve is used and sleeved onto the two reinforcing bars to be connected, and then a bonding agent for example, cement mortar is applied to the inside of the sleeve to secure the sleeve and the reinforcing bars together. The common drawback of the conventional design is the difficulty in job-site inspection. When checking a big number of workpieces at the job-site, it consumes much time, and sampling inspection is commonly adopted. However, sampling inspection cannot eliminate quality issues, resulting in high risk of engineering safety.

Therefore, it is desirable to provide a visual inspection coupler that eliminates the aforesaid problem.

### SUMMARY OF THE INVENTION

The main object of the present invention is to provide a visual inspection coupler, which enables the inspector to check the reliability of the connection of the connected members visually.

To achieve this and other objects of the present invention and according to one aspect of the present invention, the visual inspection coupler comprises a female connector and a male connector respectively fixedly fastened to a respective transverse side of each of the two members to be connected. The female connector has at least one transversely extended coupling groove. The male connector fits the female connector, having at least one transversely extended coupling rib adapted for engaging into the at least one coupling groove of the female connector respectively. The engagement between the at least one coupling groove and the at least one coupling rib enables the worker to inspect the connection of the two members visually. According to another aspect of the present invention, the female connector has a substantially U-shaped profile. The male connector is a block member adapted for fitting into the U-shaped female connector. The at least one coupling groove of the female connector and the at least one coupling rib of the male connector can be made having a dovetailed, rectangular, semicircular, or triangular cross section. The female connector and the male connector can be respectively fastened to the members to be connected by friction welding or screw joint. As an alternate form of the present invention, the visual inspection coupler is comprised of two female connectors respectively fixedly fastened to a respective transverse side of each of the two members to be connected, and a male connector adapted for engaging into the female connectors to secure the female connectors together. According to this embodiment, the female connectors each have at least one transversely extended coupling groove, and the male connector has a plurality of transversely extended coupling ribs adapted for engaging into the at least one transversely extended coupling groove of each of the female connectors. According to another alternate form, the visual inspection coupler is comprised of two male connectors respectively fixedly fastened to the members to be connected, and a female connector adapted for coupling to the male connectors to secure the male connectors together.

Other objects, advantages, and novel features of the invention will become more apparent from the following detailed description when taken in conjunction with the accompanying drawings.

### BRIEF DESCRIPTION OF THE DRAWINGS

FIG. 1 is a perspective exploded view of a visual inspection coupler according to a first embodiment of the present invention.

FIG. 2 is a sectional assembly view of a visual inspection coupler according to a second embodiment of the present invention.

FIG. 3 is a sectional assembly view of a visual inspection coupler according to a third embodiment of the present invention.

FIG. 4 is a sectional assembly view of a visual inspection coupler according to a fourth embodiment of the present invention.

FIG. 5 is a sectional assembly view of a visual inspection coupler according to a fifth embodiment of the present invention.

FIG. 6 is a sectional assembly view of a visual inspection coupler according to a sixth embodiment of the present invention.

FIG. 7 is a sectional assembly view of a visual inspection coupler according to a seventh embodiment of the present invention.

FIG. 8 is a sectional assembly view of a visual inspection coupler according to an eighth embodiment of the present invention.

FIG. 9 is an elevational assembly view of a visual inspection coupler according to a ninth embodiment of the present invention.

### DETAILED DESCRIPTION OF THE PREFERRED EMBODIMENT

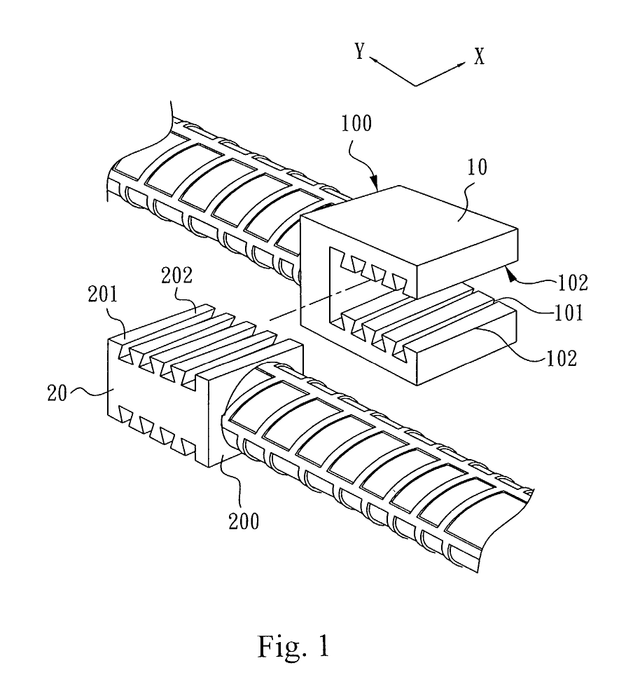

With reference to FIG. 1, a coupler in accordance with a first embodiment of the present invention is shown comprising a female connector 10 fixedly fastened to one transverse side 100 of a first member, fore example, a first reinforcing bar, and a male connector 20 fixedly fastened to one transverse side 200 of a second member (second reinforcing bar) for connection to the female connector 10 to secure the second reinforcing bar to the first reinforcing bar in a line. The transverse side 100 or 200 (X-axis direction) is perpendicular to the longitudinal direction (Y-axis direction) of the respective reinforcing bar. The female connector 10 is a substantially U-shaped block comprising two inner faces 102 disposed on the inside and facing each other and a plurality of coupling grooves 101 symmetrically transversely extended through the inner faces 102. According to this embodiment, four coupling grooves 101 are disposed in each inner face 102. The male connector 20 is a block member adapted for engaging into the female connector 10, comprising a plurality of coupling ribs 201 respectively symmetrically protruded from the two opposite peripheral sides 202 thereof and extended in transverse direction corresponding to the coupling grooves 101 in the female connector 10. By means of inserting the male connector 200 into the female connector 10 in transverse direction to force the respective coupling ribs 201 into engagement with the respective coupling grooves 101, the two reinforcing bars are connected in a line. According to this embodiment, the female connector 10 and the male connector 20 are respectively welded to the respective reinforcing bars by friction welding. The coupling grooves 101 are dovetail grooves, having sloping sidewalls of 1/100 slope. The coupling ribs 201 are dovetail ribs fitting the dovetail coupling grooves 101.

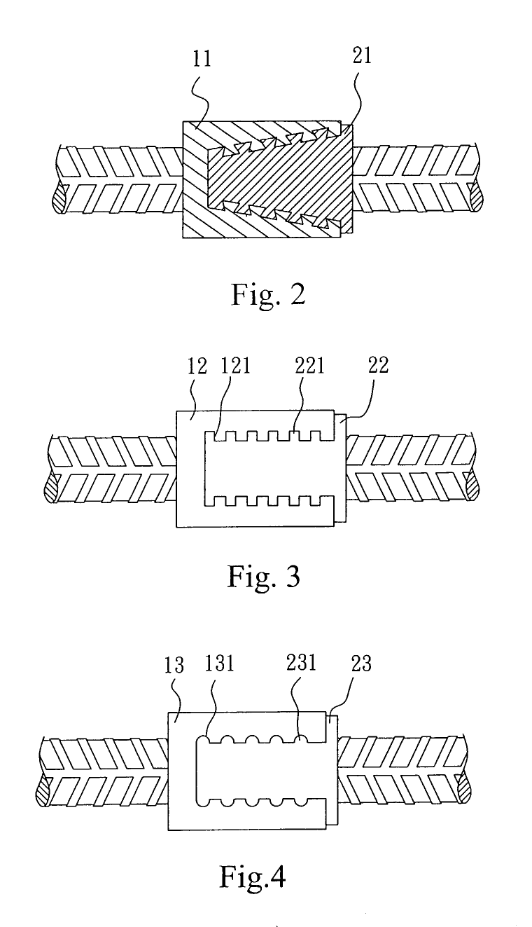

FIG. 2 illustrates a second embodiment of the present invention. According to this embodiment, the female connector 11 and the male connector 21 are respectively welded to the respective members to be connected. Alternatively, the connectors 11,21 can respectively be fastened to the respective members by a screw joint or friction welding. Further, the male connector 21 is a tapered block having a thickness gradually reducing in one direction. The female connector 11 fits over the tapered male connector 21.

FIG. 3 illustrates a third embodiment of the present invention. According to this embodiment, the coupling grooves 121 of the female connector 12 and the coupling ribs 221 of the male connector 22 have a rectangular cross section.

FIG. 4 illustrates a fourth embodiment of the present invention. According to this embodiment, the coupling grooves 131 of the female connector 13 and the coupling ribs 231 of the male connector 223 have a semicircular cross section.

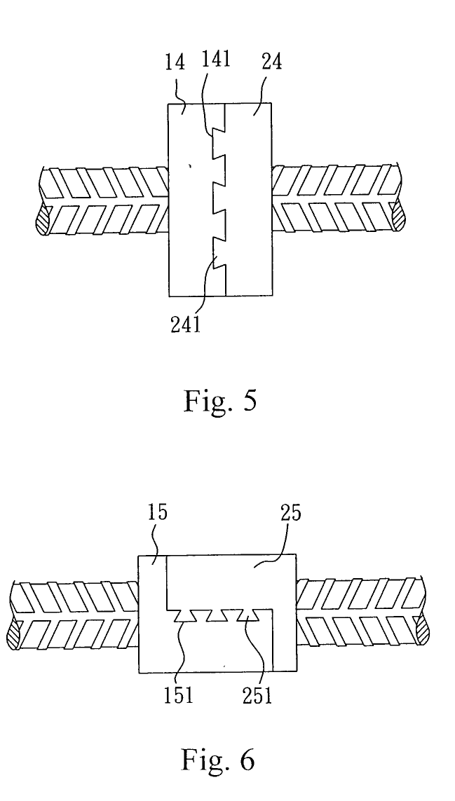

FIG. 5 illustrates a fifth embodiment of the present invention. According to this embodiment, the female connector 14 and the male connector 24 are block members having the respective coupling grooves 141 or coupling ribs 241 respectively transversely disposed at the respective abutting side. According to this embodiment, the coupling grooves 141 and the coupling ribs 241 have a dovetailed cross section. Alternatively, the coupling grooves 141 and the coupling ribs 241 can be made having a rectangular or semicircular cross section.

FIG. 6 illustrates a sixth embodiment of the present invention. According to this embodiment, the female connector 15 and the male connector 25 are angled blocks fitting each other. The coupling grooves 151 and the coupling ribs 251 may be variously embodied as stated above.

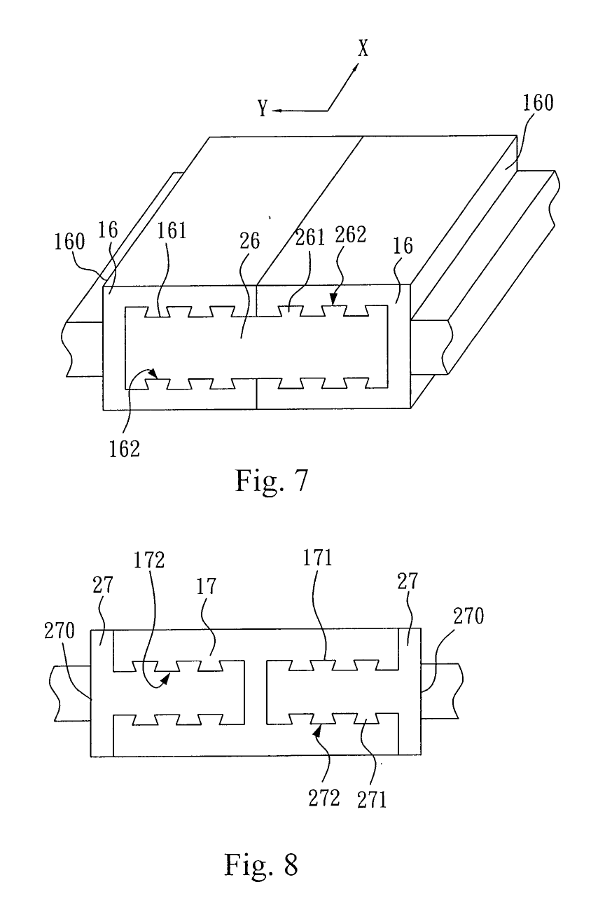

FIG. 7 illustrates a seventh embodiment of the present invention. This embodiment is adapted for use to connect plate members, for example, steel plates together. The transverse direction (X-axis direction) and longitudinal direction (Y-axis direction) are defined same as the aforesaid embodiments. According to this embodiment, the visual inspection coupler comprises two female connectors 16 respectively fixedly fastened to the respective transverse sides 160 of the plate members to be connected, and a male connector 26 adapted for engaging into the female connectors 16 to secure the female connectors 16 together. The female connectors 16 each have two opposite inner faces 612 and coupling grooves 161 in the inner faces 162. The male connector 26 is a block member having coupling ribs 261 respectively protruded from two opposite peripheral sides 262 thereof adapted for engaging into the coupling grooves 161 in the inner faces 162 of the female connectors 16.

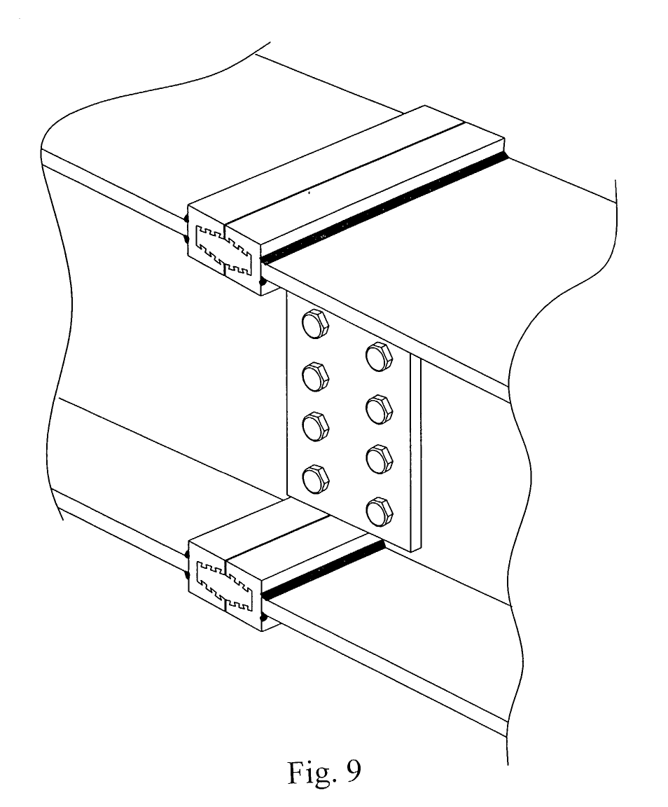

FIG. 8 illustrates an eighth embodiment of the present invention. According to this embodiment, the visual inspection coupler comprises two male connectors 27 respectively fixedly fastened to the respective transverse sides 270 of the members to be connected, and a female connector 17 of substantially I-shaped profile adapted for coupling to the male connectors 27 to secure the male connectors 27 together. The male connectors 27 each have a plurality of coupling ribs 271 transversely protruded from the respective opposite peripheral sides 272. The female connector 17 comprises coupling grooves 171 respectively transversely disposed in the opposite inner faces 172 thereof and adapted for receiving the coupling ribs 271 of the male connectors 27.

FIG. 9 illustrates a ninth embodiment of the present invention. This embodiment is similar to the aforesaid seventh embodiment, but used for connecting H-beams.

As indicated above, the visual inspection coupler of the present invention can be employed to connect reinforcing bars, steel plates, H-beams, profiled irons, etc.

Although the present invention has been explained in relation to its preferred embodiments, it is to be understood that many other possible modifications and variations can be made without departing from the spirit and scope of the invention as hereinafter claimed.

What is claimed is:

1. A visual inspection coupler adapted for connecting two members in longitudinal direction, comprising:
a female connector fixedly fastened to a transverse side of one of the two members to be connected, said female connector comprising at least one coupling groove extended in transverse direction; and
a male connector fixedly fastened to a transverse side of the other of the two members to be connected and adapted for coupling to said female connector, said male connector comprising at least one coupling rib extended in transverse direction and adapted for engaging into the at least one coupling groove of said female connector.

2 The visual inspection coupler as claimed in claim 1, wherein said female connector is a substantially U-shaped member having two opposite inner faces defining said at least one coupling groove; said male connector is a block member having said at least one coupling rib formed in peripheral sides thereof.

3. The visual inspection coupler as claimed in claim 1, wherein said at least one coupling groove and/or said at least one coupling rib are/is tapered.

4. The visual inspection coupler as claimed in claim 3, wherein the slope of the tapered at least one coupling groove and/or the tapered at least one coupling rib are/is 1/100.

5. The visual inspection coupler as claimed in claim 1, wherein said at least one coupling groove and/or said at least one coupling rib have/has a dovetailed cross section.

6. The visual inspection coupler as claimed in claim 1, wherein female connector and/or said male connector are/is respectively welded to the respective transverse sides of the two members to be connected.

7. A visual inspection coupler adapted for connecting two members in longitudinal direction, comprising:
two female connectors respectively fixedly fastened to a respective transverse side of each of the two members to be connected, said female connectors each comprising at least one coupling groove extended in transverse direction; and
a male connector adapted for engaging into said female connectors to secure said female connectors together, said male connector comprising a plurality of coupling ribs extended in transverse direction adapted for engaging into the at least one coupling groove of said female connectors.

8. The visual inspection coupler as claimed in claim 7, wherein said female connectors are substantially U-shaped members each having two opposite inner faces defining the respective at least one coupling groove; said male connector is a block member having said coupling ribs transversely symmetrically formed in peripheral sides thereof.

9. The visual inspection coupler as claimed in claim 7, wherein the coupling grooves of said female connectors and/or the coupling ribs of said male connector are/is tapered.

10. The visual inspection coupler as claimed in claim 9, wherein the slope of the tapered coupling grooves and/or the tapered coupling ribs are/is 1/100.

11. The visual inspection coupler as claimed in claim 7, wherein the coupling grooves of said female connectors and/or the coupling ribs of said male connector have/has a dovetailed cross section.

12. The visual inspection coupler as claimed in claim 7, wherein said female connectors and/or said male connector are/is respectively welded to the respective transverse sides of the two members to be connected.

13. A visual inspection coupler adapted for connecting two members in longitudinal direction, comprising:
two male connectors respectively fixedly fastened to a respective transverse side of each of the two members to be connected, said male connectors each comprising at least one coupling rib extended in transverse direction; and
a female connector adapted for receiving said male connectors to secure said male connectors together, said female connector comprising a plurality of coupling grooves extended in transverse direction adapted for receiving the at least one coupling groove of each of said female connector.

14. The visual inspection coupler as claimed in claim 13, wherein said female connector is substantially I-shaped member having two pairs of opposite inner faces defining said coupling grooves; said male connectors are block member having the respective at least one coupling rib respectively transversely formed in at least one of two opposite peripheral sides thereof.

15. The visual inspection coupler as claimed in claim 13, wherein the coupling grooves of said female connector and/or the coupling ribs of said male connectors are/is tapered.

16. The visual inspection coupler as claimed in claim 15, wherein the slope of the tapered coupling grooves and/or the tapered coupling ribs are/is 1/100.

17. The visual inspection coupler as claimed in claim 13, wherein the coupling grooves of said female connector and/or the coupling ribs of said male connectors have/has a dovetailed cross section.

18. The visual inspection coupler as claimed in claim 13, wherein said female connector and/or said male connectors are/is respectively welded to the respective transverse sides of the two members to be connected.
